(19) United States
(12) Patent Application Publication
(10) Pub. No.: US 2014/0236741 A1
(43) Pub. Date: Aug. 21, 2014

(54) DISPLAY DEVICE AND DISPLAY METHOD

(71) Applicants: Masaki Hashiura, Osaka-shi (JP); Masahiro Ueda, Osaka-shi (JP); Kei Iwata, Osaka-shi (JP); Yoshiharu Yoshimoto, Osaka-shi (JP)

(72) Inventors: Masaki Hashiura, Osaka-shi (JP); Masahiro Ueda, Osaka-shi (JP); Kei Iwata, Osaka-shi (JP); Yoshiharu Yoshimoto, Osaka-shi (JP)

(73) Assignee: SHARP KABUSHIKI KAISHA, Osaka-shi, Osaka (JP)

(21) Appl. No.: 14/347,691

(22) PCT Filed: Jul. 19, 2012
(86) PCT No.: PCT/JP2012/068281

§ 371 Date: Mar. 27, 2014

(30) Foreign Application Priority Data
Oct. 31, 2011 (JP) 2011-238800

(51) Int. Cl. G06Q 30/02

(52) U.S. Cl. CPC G06Q 30/0277
USPC 705/14.73

(57) ABSTRACT

When a processing unit generates a display screen based on display data generated from a plurality of respective content data, and causes a display unit to display a predetermined area of the display screen, the processing unit reads stored previous arrangements of the content data in the display screen, and changes the arrangements of the plurality of respective content data in the display screen at predetermined timing, in accordance with a preset rule. Then, the processing unit stores the arrangements.

### TECHNICAL FIELD

The present invention relates to a display device and a display method, and in particular to a display device and a display method for performing display based on content data.

### BACKGROUND ART

There is a mechanism by which an advertisement content as distribution data is generated from a plurality of advertisements as content data, distributed, and displayed in a display device as a distribution destination.

While distributed advertisements tend to be increased, the display area of a display device used, for example a portable terminal, tends to be relatively decreased.

Thus, as a method for displaying such distribution data, for example, Japanese Patent Laying-Open No. 2002-304142 (PTD 1) proposes a method for displaying only some of a plurality of distributed advertisements in a window and scrolling the advertisements. Further, as a method for displaying a banner advertisement on a web site, a method for displaying banner advertisements by rotating display positions at regular time intervals is widely adopted.

### CITATION LIST

### Patent Document

PTD 1: Japanese Patent Laying-Open No. 2002-304142

### SUMMARY OF INVENTION

### Technical Problem

Some advertisements have priorities of display which are set higher, or have higher degrees of importance. However, when the display method disclosed in PTD 1 is adopted, there is a problem that such priorities or degrees of importance are not taken into account when the advertisements have opportunities to be displayed.

Further, there is another problem that, in a case where an advertisement content is once distributed and thereafter displayed a plurality of times, when the opportunities that the advertisements are displayed in previous display and the opportunities that the advertisements are displayed in subsequent display are considered comprehensively, the opportunities that the advertisements are displayed are unequal, or the priorities, degrees of importance, or the like set for the respective advertisements are not taken into account.

The present invention has been made in view of the aforementioned problems, and one object of the present invention is to provide a display device and a display method capable of displaying an advertisement content, which is distribution data generated from a plurality of respective content data as a plurality of advertisements, with each content data being displayed at an appropriate opportunity.

### Solution to Problem

In order to achieve the above object, in accordance with an aspect of the present invention, a display device includes a storage unit for storing display data generated from a plurality of respective content data, a display unit, and a processing unit for generating a display screen based on the display data and causing the display unit to display a predetermined area of the display screen. The processing unit performs processing of changing arrangements of the plurality of respective content data in the display screen at predetermined timing, in accordance with a preset rule, and processing of storing the arrangements of the plurality of respective content data in the display screen when display based on the display data is terminated. The processing unit determines arrangements changed in accordance with the rule from arrangements of the plurality of respective content data in the display screen when previous display based on the display data is terminated, which have been stored by the processing of storing, as arrangements of the plurality of respective content data in the display screen when next display based on the display data is started.

Preferably, the display device further includes a reception unit for receiving designation of specific content data of the plurality of content data included in the display data. The processing unit sets an arrangement of the designated content data in the display screen at a predefined position, and, in the processing of changing the arrangements, changes arrangements of content data other than the designated content data of the plurality of content data, at positions other than the predefined position in the display screen, at the predetermined timing.

Preferably, in the processing of changing the arrangements, the processing unit changes the arrangements in accordance with priorities of display defined for the plurality of respective content data, at positions predefined in response to the priorities on the display screen.

More preferably, in the processing of changing the arrangements, the processing unit arranges content data with a higher priority of display of the plurality of content data, within a range of the display screen which is more frequently displayed in the display unit.

Preferably, in the processing of changing the arrangements, the processing unit fixes content data with a higher priority of display of the plurality of content data, at a predefined position in the display screen, and changes arrangements of content data other than the content data with the higher priority of the plurality of content data, at positions other than the predefined position in the display screen, at the predetermined timing.

In accordance with another aspect of the present invention, a display method is a method for generating a display screen based on display data generated from a plurality of respective content data and displaying a predetermined area of the display screen in a display device, including the steps of: determining arrangements of the plurality of respective content data in the display screen; changing the arrangements of the plurality of respective content data in the display screen at predetermined timing, in accordance with a preset rule; and storing the arrangements of the plurality of respective content data in the display screen when display based on the display data is terminated. When next display based on the display data is started, the step of determining the arrangements determines arrangements changed in accordance with the rule from arrangements of the plurality of respective content data in the display screen when previous display based on the display data is terminated, which have been stored by the step of storing, as arrangements of the plurality of respective content data in the display screen when the next display based on the display data is started.

In accordance with still another aspect of the present invention, a display program is a program for causing a display device to perform processing of generating a display screen based on display data generated from a plurality of respective content data and displaying a predetermined area of the display screen, causing the display device to perform the steps of: determining arrangements of the plurality of respective content data in the display screen; changing the arrangements of the plurality of respective content data in the display screen at predetermined timing, in accordance with a preset rule; and storing the arrangements of the plurality of respective content data in the display screen when display based on the display data is terminated. When next display based on the display data is started, the step of determining the arrangements determines arrangements changed in accordance with the rule from arrangements of the plurality of respective content data in the display screen when previous display based on the display data is terminated, which have been stored by the step of storing, as arrangements of the plurality of respective content data in the display screen when the next display based on the display data is started.

### Advantageous Effects of Invention

According to the present invention, when distribution data, which is an advertisement content generated from a plurality of respective content data as a plurality of advertisements, the advertisement content can be displayed with each content data being displayed at an appropriate opportunity. In particular, even when the display device has a small display area and all the plurality of content data cannot be displayed at once, the advertisement content can be displayed with the plurality of content data being displayed at appropriate opportunities.

### BRIEF DESCRIPTION OF DRAWINGS

FIG. 1 is a view showing a specific example of a configuration of an advertisement system (hereinafter referred to as a system) in accordance with an embodiment.

FIG. 2 is a block diagram showing a specific example of a device configuration of a generation device included in the system.

FIG. 3 is a view for illustrating flows of data in the system.

FIG. 4 is a view showing a flow of operations in the system.

FIG. 5 is a view for illustrating a data configuration of an advertisement content.

FIG. 6 is a block diagram showing a specific example of a functional configuration of the generation device.

FIG. 7 is a flowchart showing a specific flow of an operation of generating and distributing the advertisement content in the generation device.

FIG. 8 is a view showing a specific example of catalog lists.

FIG. 9 is a flowchart showing a specific flow of an operation in step S103 of FIG. 7.

FIG. 10A is a view for illustrating another example of grouping of catalog data.

FIG. 10B is a view for illustrating another example of grouping of catalog data.

FIG. 11 is a flowchart showing a specific flow of an operation in step S107 of FIG. 7.

FIG. 12 is a view showing a specific example of a distribution registration history.

FIG. 13A is a view for illustrating a method for extracting catalog data to be published in the advertisement content.

FIG. 13B is a view for illustrating the method for extracting catalog data to be published in the advertisement content.

FIG. 14 is a block diagram showing a specific example of a functional configuration of a terminal device.

FIG. 15 is a flowchart showing a specific flow of an operation of displaying the advertisement content in the terminal device.

FIG. 16 is a view for illustrating a specific example of arrangements of catalogs in a display screen.

FIG. 17 is a view for illustrating a first rotation method.

FIG. 18 is a view for illustrating a second rotation method.

FIG. 19 is a view for illustrating a third rotation method.

FIG. 20 is a view for illustrating a specific example of arrangements of catalogs in a display screen in a case where there is a catalog with a “bookmark” added.

FIG. 21 is a view for illustrating the first rotation method in the case where there is catalog data with a “bookmark” added.

FIG. 22 is a view for illustrating the second rotation method in the case where there is catalog data with a “bookmark” added.

FIG. 23 is a view for illustrating the third rotation method in the case where there is catalog data with a “bookmark” added.

FIG. 24A is a view showing a display example in the case where there is a catalog with a “bookmark” added.

FIG. 24B is a view showing the display example in the case where there is a catalog with a “bookmark” added.

FIG. 25A is a view showing a display example in a case where there is a catalog for which a viewing history has been registered.

FIG. 25B is a view showing the display example in the case where there is a catalog for which a viewing history has been registered.

### DESCRIPTION OF EMBODIMENTS

Hereinafter, embodiments of the present invention will be described with reference to the drawings. In the following description, identical parts and components will be designated by the same reference numerals. Their names and functions are also the same.

<System Configuration>

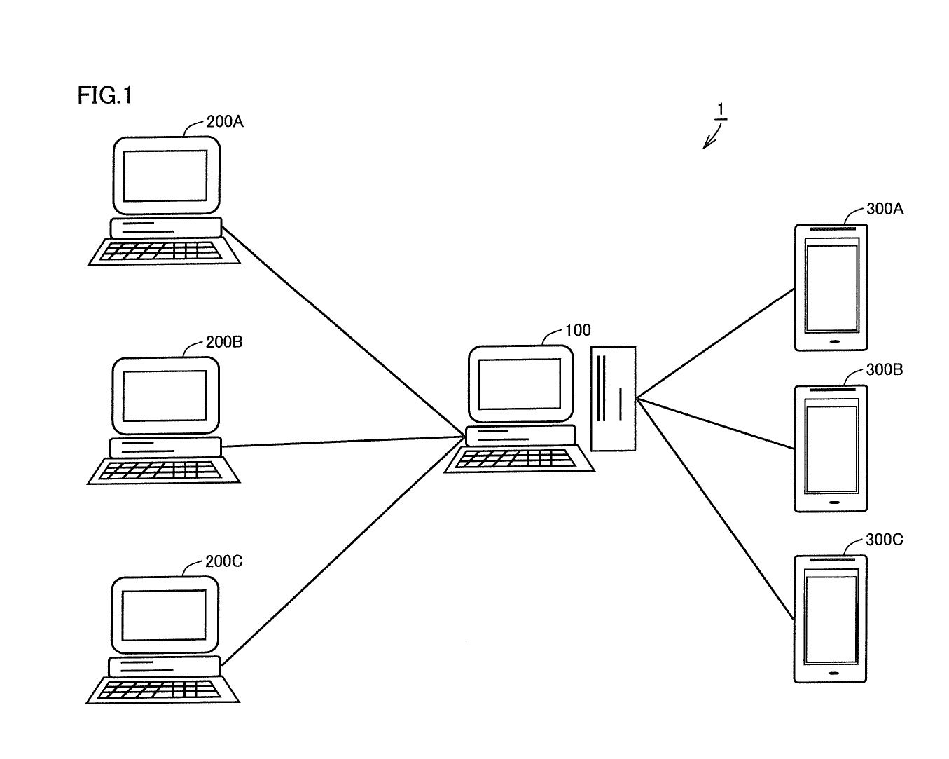

FIG. 1 is a view showing a specific example of a configuration of an advertisement system (hereinafter referred to as a system) 1 in accordance with the present embodiment.

Referring to FIG. 1, system 1 in accordance with the present embodiment includes a generation device 100 as a device for generating and distributing an advertisement content, provision devices 200A, 200B, 200C as devices connected to generation device 100 for providing catalog data, and terminal devices 300A, 300B, 300C connected to generation device 100 for receiving distribution of the advertisement content and displaying the advertisement content.

System 1 includes a plurality of provision devices 200A, 200B, 200C and a plurality of terminal devices 300A, 300B, 300C. These devices will also be referred to representatively as provision devices 200 and terminal devices 300.

Generation device 100 and provision device 200 may be each configured as an ordinary personal computer or the like. Terminal device 300 is preferably configured as a portable terminal device such as a mobile phone, a book viewing device, or a small-sized personal computer. Terminal device 300 may also be configured as an ordinary personal computer.

Generation device 100 and provision device 200 may be connected with each other via a dedicated line, or via a public line such as the Internet. Further, communication therebetween may be wired or wireless.

Generation device 100 and terminal device 300 may also be connected with each other via a dedicated line, or via a public line such as the Internet. While communication therebetween may be wired or wireless, when terminal device 300 is configured as a portable terminal device such as a mobile phone or a book viewing device, wireless communication is performed therebetween.

<Device Configuration>

As described above, any of the devices included in system 1 is configured as an ordinary personal computer, a mobile phone, or the like.

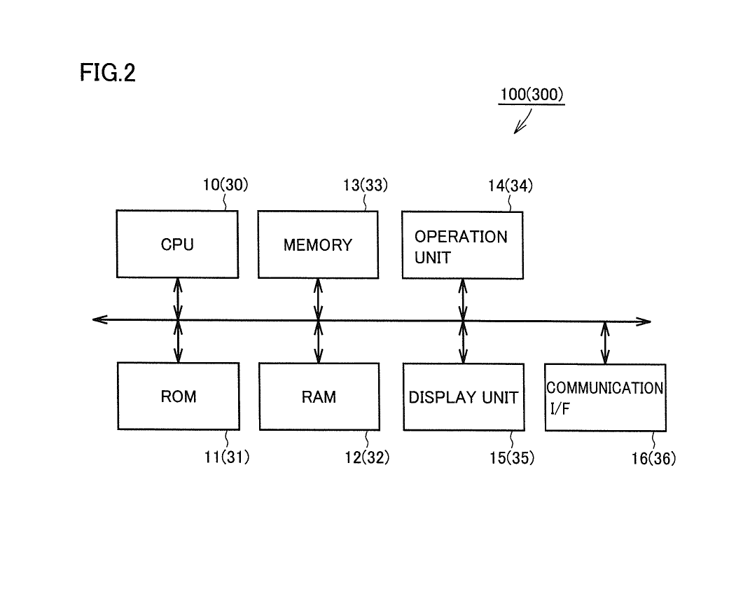

As an example, FIG. 2 is a block diagram showing a specific example of a device configuration of generation device 100 when it is configured as an ordinary personal computer. The configuration shown in FIG. 2 is of an ordinary personal computer, and generation device 100 is not limited to have the configuration shown.

Specifically, referring to FIG. 2, as an example, generation device 100 includes a CPU (Central Processing Unit) 10 as an arithmetic device for controlling the entire device, a ROM (Read Only Memory) 11 for storing programs and the like to be executed by CPU 10, a RAM (Random Access Memory) 12 for serving as a work area when CPU 10 executes a program, a memory 13 for saving catalog data, advertisement contents, and the like described later, an operation unit 14 for receiving an operation input to generation device 100, a display unit 15 for displaying information, and a communication I/F 16 for communicating with provision device 200 and terminal device 300.

It is noted that, as described above, terminal device 300 may also be configured as an ordinary personal computer or the like. Accordingly, terminal device 300 has the same configuration as that of generation device 100 shown in FIG. 2. Thus, terminal device 300 also includes a CPU 30, a ROM 31, a RAM 32, a memory 33, an operation unit 34, a display unit 35, and a communication I/F 36 designated by reference numerals in parentheses in FIG. 2.

<Operation Overview>

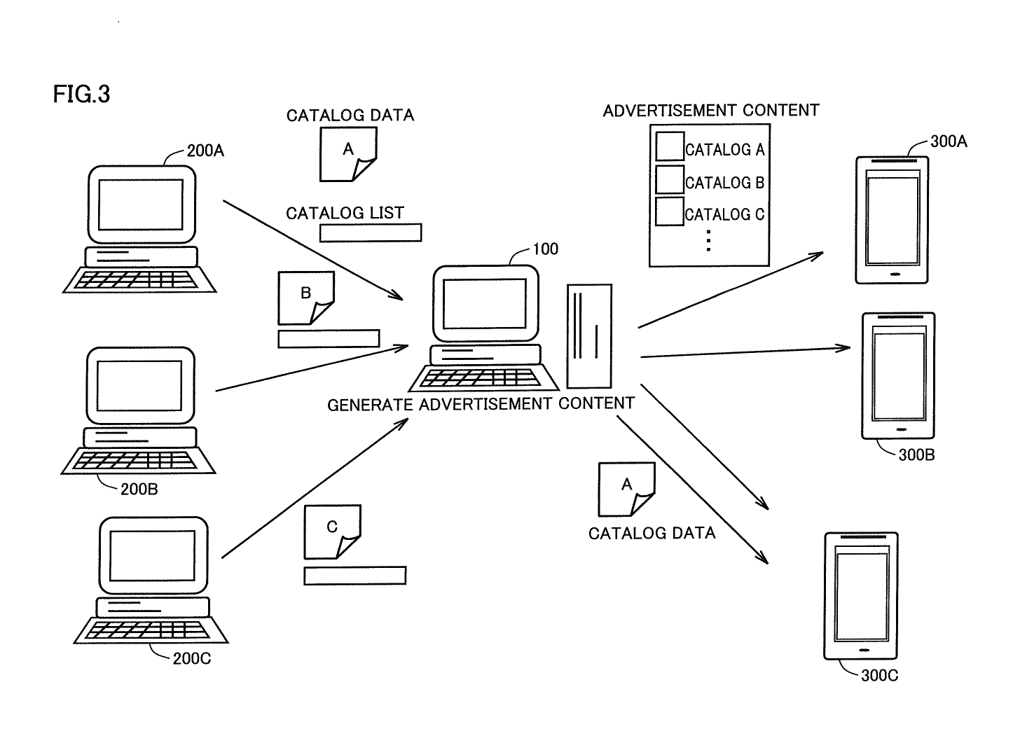

FIG. 3 is a view for illustrating flows of data in system 1.

Referring to FIG. 3, in system 1, catalog data and a catalog list are provided from each provision device 200 to generation device 100.

The data provided herein refers to data for display for which a display expiration date is set, and as an example, refers to data for allowing display of a catalog, a so-called leaflet or pamphlet, and the like for introducing a commodity and introducing or providing how to purchase the commodity. Although the provided data is referred to as “catalog data” in the following example, the provided data is not necessarily limited to data for introducing a commodity and introducing or providing how to purchase the commodity, and the provided data may be any display data for which a display expiration date is set.

Further, the catalog list refers to information indicating information for generating an advertisement content for each catalog data. Specific contents thereof will be described later, taking a specific example.

It is noted that, although both the catalog data and the catalog list are provided from provision device 200 to generation device 100 in this example, the catalog list may be provided from a device different from the device which provides the catalog data.

In generation device 100, an advertisement content is generated using the catalog data from provision devices 200. The generated advertisement content is distributed from generation device 100 to terminal devices 300. Further, the catalog data is transmitted from generation device 100 to terminal device 300.

Here, the advertisement content refers to one data for display having a plurality of combined catalog data. A specific content thereof will be described later.

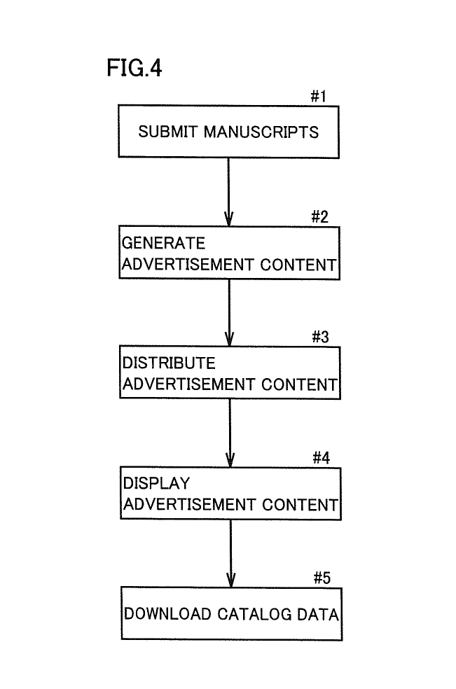

FIG. 4 is a view showing a flow of operations in system 1.

Referring to FIG. 4, first, catalog data are provided from provision devices 200 to generation device 100 (#1). This operation will also be referred to as “manuscript submission”.

Generation device 100 generates an advertisement content using the catalog data provided from provision devices 200 (#2).

Generation device 100 distributes the generated advertisement content to terminal devices 300 registered beforehand, at predetermined timing (#3). The distribution herein is so-called push-type distribution, in which distribution is performed in response to the timing in generation device 100. In each terminal device 300, display is performed based on the received advertisement content (#4).

When there is a request from terminal device 300, designated catalog data is downloaded from generation device 100 to terminal device 300 (#5).

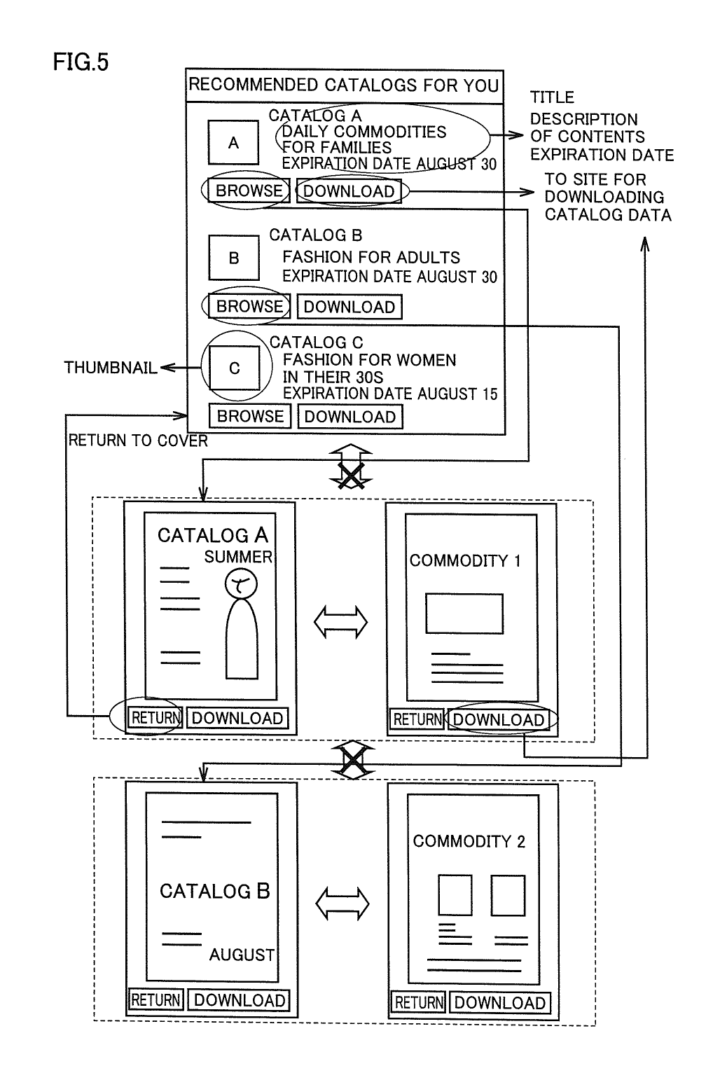

FIG. 5 is a view for illustrating a data configuration of an advertisement content.

Referring to FIG. 5, when display based on the advertisement content is performed in the terminal device, a cover page is displayed.

The cover page based on the advertisement content includes, for each catalog data constituting the advertisement content, a thumbnail indicating a corresponding catalog, the title of the catalog, a description of contents, and an indication of an expiration date. Further, for each catalog, a “Browse” button for giving an instruction to display a representative portion and a “Download” button for giving an instruction to download the entire catalog data are displayed.

The advertisement content includes representative pages for each catalog. The representative pages refer to pages displayed based on at least a portion of the catalog data, for example the cover of the catalog, a page showing a recommended commodity in the catalog, and the like.

When the “Browse” button for each catalog included in the cover page based on the advertisement content is pressed, display transitions from the cover page based on the advertisement content to a cover page of a corresponding catalog. Without pressing the “Browse” button, display cannot transition from the cover page based on the advertisement content to the cover page of each catalog, for example by an operation such as scrolling.

The pages of each catalog include indications of a “Return” button for giving an instruction to display the cover page based on the advertisement content and a “Download” button for giving an instruction to download the entire catalog data.

When the “Return” button included in a page of a catalog is pressed, display transitions from the page of the catalog to the cover page based on the advertisement content. Then, when the “Browse” button for another catalog included in the cover page is pressed, display transitions from the cover page based on the advertisement content to a cover page of the corresponding catalog. Without pressing the “Return” button to return display once to the cover page based on the advertisement content, display cannot transition from a page of a catalog to a page of another catalog, for example by an operation such as scrolling.

When the “Download” button included in a page of each catalog or the “Download” button for each catalog included in the cover page based on the advertisement content is pressed, display transitions to a site for downloading the entire corresponding catalog data, allowing download of the catalog data.

### First Embodiment

As a first embodiment, generation and distribution of an advertisement content in generation device 100 described above in #2 and #3 will be described.

<Functional Configuration>

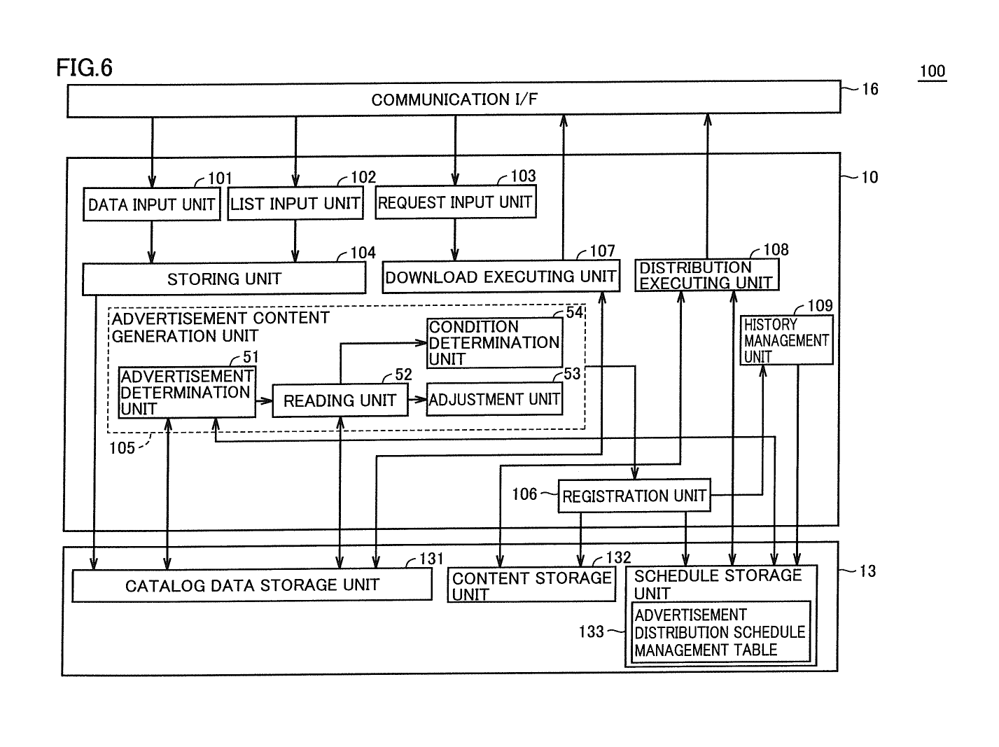

FIG. 6 is a block diagram showing a specific example of a functional configuration for performing the above operation in generation device 100.

Each function shown in FIG. 6 is mainly configured on CPU 10 of generation device 100 by CPU 10 reading a program stored in ROM 11, loading the program into RAM 12, and executing the program. However, at least a portion thereof may be implemented by the hardware configuration shown in FIG. 2.

Referring to FIG. 6, generation device 100 includes, in memory 13, a catalog data storage unit 131 as a storage area for storing catalog data and catalog lists, a content storage unit 132 as a storage area for storing advertisement contents, and a schedule storage unit 133 as an area for storing distribution schedules and distribution histories of the advertisement content in the form of, for example, a management table.

Further, as functions for generating and distributing an advertisement content, generation device 100 includes a data input unit 101 for receiving inputs of catalog data from provision devices 200 via communication I/F 16, a list input unit 102 for receiving inputs of catalog lists from provision devices 200 via communication I/F 16, a request input unit 103 for receiving a request to download catalog data from terminal device 300 via communication I/F 16, a storing unit 104 for storing the catalog data and the catalog lists from provision devices 200 in catalog data storage unit 131, an advertisement content generation unit 105 for generating an advertisement content using the catalog data, a registration unit 106 for registering the generated advertisement content with content storage unit 132 and registering distribution conditions described later with schedule storage unit 133, a download executing unit 107 for executing download of the catalog data, a distribution executing unit 108 for executing distribution of the advertisement content, and a history management unit 109 for registering a registration history of the advertisement content (distribution registration history) with schedule storage unit 133.

Further, advertisement content generation unit 105 includes an advertisement determination unit 51 for determining catalog data to be used to generate an advertisement content, a reading unit 52 for reading the catalog data to be used from catalog data storage unit 131, an adjustment unit 53 for adjusting a file size of the advertisement content and a publication position and a publication size of a catalog in the advertisement content, and a condition determination unit 54 for determining distribution conditions such as an expiration date and a distribution timing of the advertisement content, and the like.

<Flow of Operation>

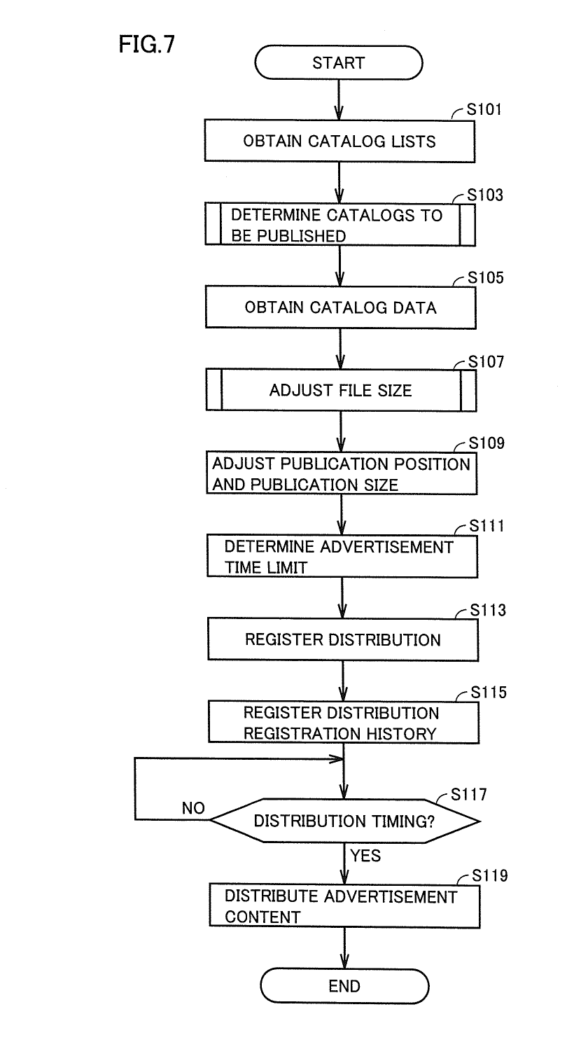

FIG. 7 is a flowchart showing a specific flow of the operation of generating and distributing an advertisement content in generation device 100. The operation shown in the flowchart of FIG. 7 is implemented by CPU 10 of generation device 100 reading a program stored in ROM 11, loading the program into RAM 12 and executing the program, and causing each function in FIG. 6 to be exhibited.

Referring to FIG. 7, in step S101, CPU 10 reads and obtains catalog lists of catalog data stored in catalog data storage unit 131.

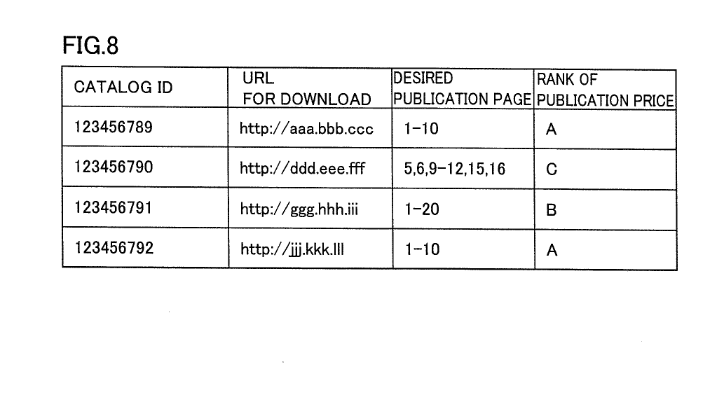

FIG. 8 is a view showing a specific example of the catalog lists. As an example, the catalog list is provided from provision device 200 for each catalog data, as described above. Further, as another example, the catalog lists may be provided from a device different from the devices which provide the catalog data, as information about several catalog data. FIG. 8 shows a specific example of the catalog lists in the latter case.

Specifically, referring to FIG. 8, the catalog list at least includes, for each catalog data, a catalog ID for specifying the catalog data, which is information such as a character string, and access information for accessing a site for downloading the entire catalog data, for example an URL (Uniform Resource Locator).

In addition, the catalog list may include information designating pages to be published in an advertisement content (i.e., desired publication pages), for example by providing comma-separated page numbers. The page designated herein is provided to designate an area of the catalog data to be published in the advertisement content, and an area within the designated area (page) is published in the advertisement content. Specifically, in the processing of adjusting the file size described later, the catalog data to be published in the advertisement content may become smaller than the designated area, but there is no possibility that an area larger than the designated area is published.

It is noted that, when the page to be published is not designated, it may be extracted from the first page in the operation of adjusting the file size described later.

Further, the catalog list may include a rank of a publication price, or the like, as an attribute of the catalog data. FIG. 8 shows an example in which the catalog list includes a rank of a publication price for each catalog data. As the rank of the publication price, for example, a rank such as A, B, C . . . may be specified for each price plan according to a price, a payment method, and the like. Further, another example of the attribute of the catalog data may include, for example, the degree of importance, priority, and the like of the corresponding catalog.

In step S103, CPU 10 determines catalogs to be published in an advertisement content.

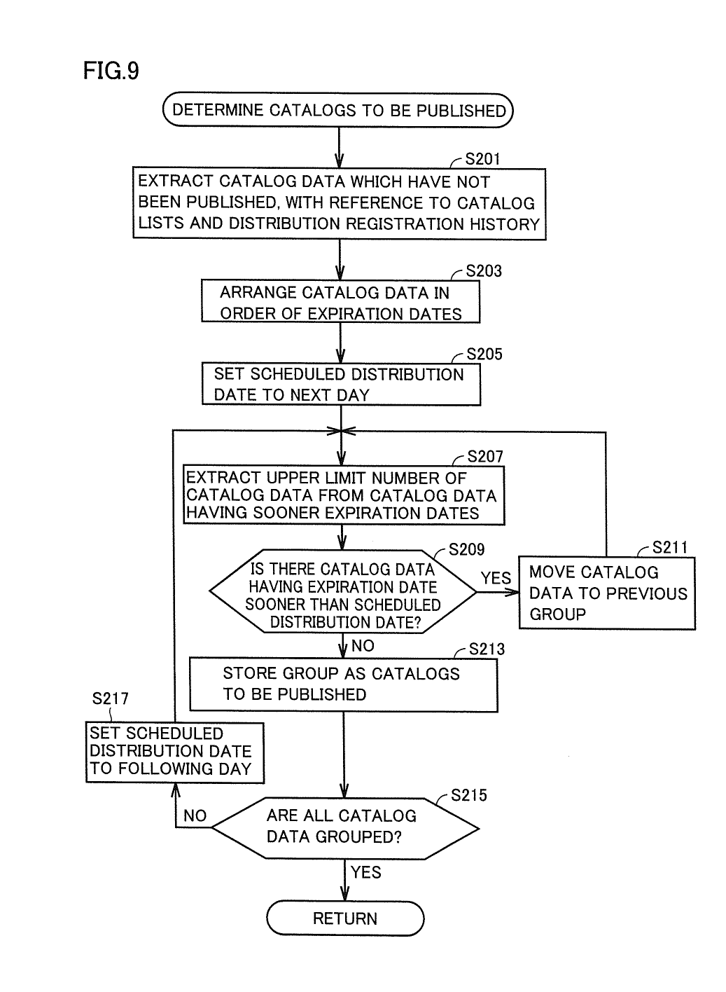

FIG. 9 is a flowchart showing a specific flow of an operation in step S103.

Referring to FIG. 9, CPU 10 extracts catalog data which have not been published in advertisement contents generated so far, from catalog data storage unit 131, with reference to the catalog lists and distribution registration history (step S201). This is intended to avoid a catalog from being distributed redundantly in a plurality of advertisement contents, and this method will be described later.

On this occasion, if generation conditions for the advertisement content which designate, for example, the title of a commodity, the author, writer of a commodity, the category of a commodity, and the like are predefined, CPU 10 extracts catalog data which have not been published and satisfy the generation conditions.

Here, in principle, catalog data which has already been published in the advertisement contents generated before is excluded. However, depending on the attribute of the catalog data such as, for example, the rank of the publication price, the degree of importance of the catalog, and the like, catalog data which has been published before may be extracted to be published again.

CPU 10 sorts the extracted catalog data in the order of expiration dates set respectively (step S203), and sets a scheduled distribution date for the advertisement content to the next day of a date when the advertisement content is generated (step S205). Then, CPU 10 extracts a predefined upper limit number of catalog data from the catalog data sorted in the order of expiration dates, from the one having a sooner expiration date (S207).

When a group of the catalog data extracted in step S207 includes catalog data having an expiration date sooner than the scheduled distribution date set in step S205 (YES in step S209), CPU 10 moves the catalog data to a group immediately previous to the group (step S211).

On the other hand, when all the catalog data in the group of the catalog data extracted in step S207 have expiration dates later than the scheduled distribution date set in step S205 (NO in step S209), CPU 10 determines this group as catalog data to be published in the advertisement content, and stores this group (step S213).

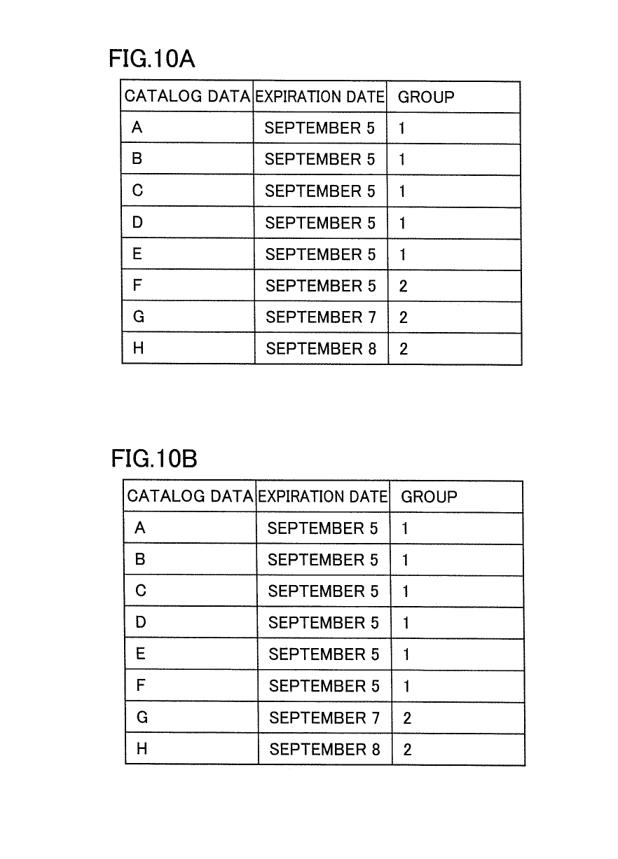

It is noted that the predefined upper limit number described above may be changed by CPU 10. For example, when the catalog data extracted in step S201 are grouped on the assumption that the predefined upper limit number is 5, the catalog data are grouped as shown in FIG. 10A. On this occasion, if the scheduled distribution date for the advertisement content is set to September 5, in the example shown in FIG. 10A, the number of catalog data whose expiration dates are expired on the scheduled distribution date is six, which is more than 5 as the upper limit number. Accordingly, in this case, CPU 10 may change the upper limit number of catalog data in a first group to 6, as shown in FIG. 10B.

The above operation is performed to group all the catalog data extracted in step S201, with the scheduled distribution date being set to the following day one by one (step S217). When all the catalog data are grouped (YES in step S215), CPU 10 terminates a series of operations and returns to the operation of FIG. 7.

Specifically, when CPU 10 determines catalog data to be published in the advertisement content in step S103, CPU 10 reads and obtains the corresponding catalog data from catalog data storage unit 131 in step S105. Then, CPU 10 adjusts the file size of the advertisement content in step S107.

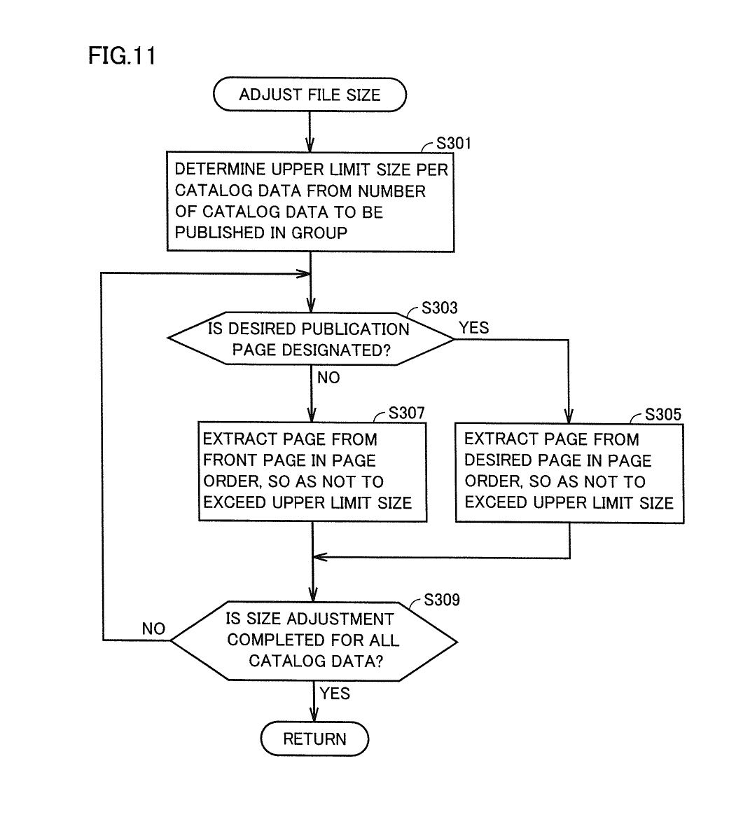

FIG. 11 is a flowchart showing a specific flow of an operation in step S107.

Referring to FIG. 11, CPU 10 determines an upper limit size per data from the number of catalog data included in the group of the catalog data determined in step S103 (step S301). As an example, here, the upper limit size per data is obtained by dividing a size upper limit of the entire group by the number of catalog data included in the group.

It is noted that, on this occasion, a size for each catalog data may be specified in accordance with the attribute of the catalog data such as the rank of the publication price included in the catalog list. Specifically, the size for each catalog data may be determined by dividing the size upper limit of the entire group by the number of catalog data included in the group as described above, taking the attribute of the catalog data into account as a weighting factor.

Thereafter, CPU 10 extracts an area (pages) to be published in the advertisement content, for each catalog data. Specifically, CPU 10 extracts pages so as not to exceed the upper limit size determined in step S301, from a designated page when desired publication pages are designated in the catalog list for the catalog data to be processed (YES in step S303; S305), or from a predefined page, for example, the front page or the like when desired publication pages are not designated (NO in step S303; S307).

When size adjustment is completed by performing the above operation on all the catalog data in the group determined in step S103 (YES in step S309), CPU 10 terminates a series of operations and returns to the operation of FIG. 7.

Specifically, when file size adjustment for each catalog data is completed in step S107, in step S109, CPU 10 adjusts a publication position and a publication size for each catalog data, and generates the advertisement content in accordance with results thereof. Specifically, CPU 10 arranges the pages extracted for each catalog data in step S107, in accordance with the publication position and the publication size, and generates the advertisement content. Further, CPU 10 includes the publication position and the publication size, which are the results of the adjustment, in the advertisement content, as reproduction conditions for the advertisement content.

Here, as an example, a publication order and the publication size may be determined in accordance with the attribute of the catalog data such as the rank of the publication price included in the catalog list. Further, as another example, if the generation conditions for the advertisement content described above are predefined, the publication order and the publication size may be determined based on these conditions.

Next, in step S111, CPU 10 determines an expiration date, which is a display time limit, of the advertisement content, as a distribution condition. Here, as an example, the longest (latest) expiration date of the expiration dates set for the catalog data published in the advertisement content may be set as the expiration date of the advertisement content. Further, as another example, the shortest (soonest) expiration date of the expiration dates set for the catalog data published in the advertisement content may be set as the expiration date of the advertisement content. As still another example, the expiration date of the advertisement content may be set such that, of the catalog data published in the advertisement content, a predetermined number of the catalog data have expiration dates later than the expiration date of the advertisement content.

Further, in step S111, other distribution conditions such as the distribution timing may also be determined.

When the above operation is completed, in step S113, CPU 10 registers the generated advertisement content with content storage unit 132 as an advertisement content to be distributed, and registers the distribution conditions determined in step S111 with schedule storage unit 133. Further, in step S115, CPU 10 registers the distribution conditions such as the distribution timing and a time limit of an advertisement content determined in step S111, as a distribution registration history, for each catalog data published in the advertisement content.

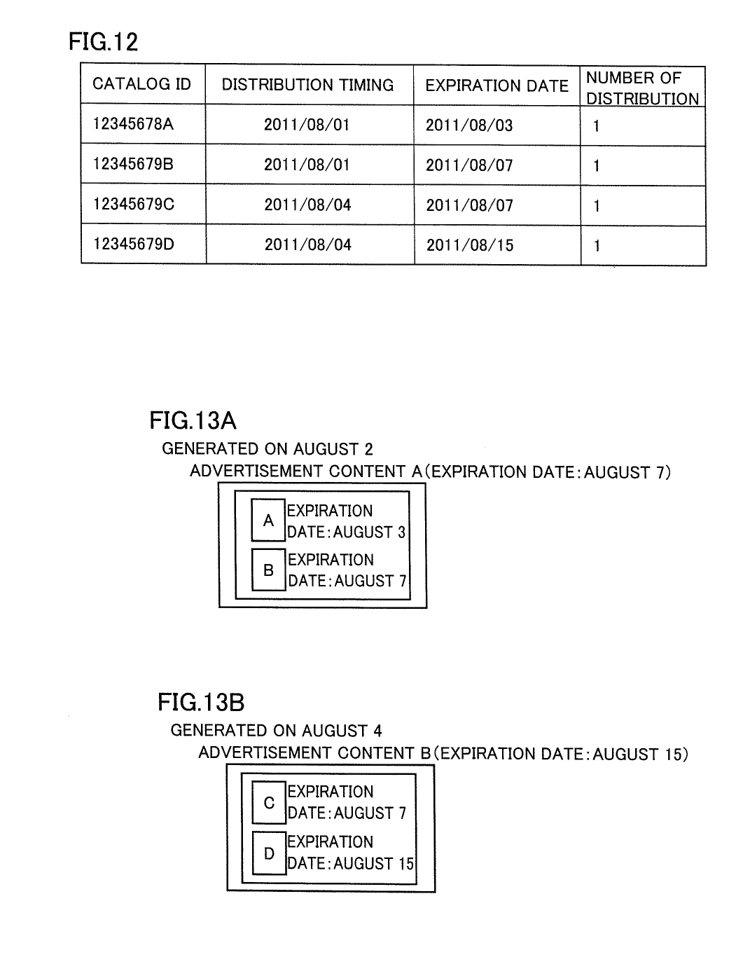

FIG. 12 is a view showing a specific example of the distribution registration history registered in step S115.

Referring to FIG. 12, in step S115, as an example, CPU 10 causes, for each catalog data, the distribution timing of the advertisement content in which the catalog data is published, the expiration date of the advertisement content, and the number of times the catalog data is published in the advertisement content (i.e., distribution number), to be stored as a history of the advertisement content to be distributed registered with content storage unit 132.

The distribution registration history registered in step S115 is used when catalogs to be published in the advertisement content are determined in step S103. Specifically, as described above, in step S103, CPU 10 extracts catalog data which have not been published in advertisement contents generated so far, from catalog data storage unit 131, with reference to the catalog lists and distribution registration histories (step S201). This is intended to avoid a situation where, if a subsequent advertisement content is distributed before an expiration date of an advertisement content, and both advertisement contents include the same catalog data, the same catalog is displayed redundantly in both advertisement contents.

A method for extracting the catalog data to be published in the advertisement content in step S201 will be specifically described with reference to FIGS. 13A and 13B.

Specifically, it is assumed that, prior to August 3 (for example, on August 2), it is determined in generation device 100 that catalog data A and catalog data B are to be published in an advertisement content A as shown in FIG. 13A. Since the expiration date of catalog data A is set to August 3, and the expiration date of catalog data B is set to August 7, CPU 10 determines in step S111 that August 7, which is the later one of the expiration dates, is the expiration date of the advertisement content, as a distribution condition.

Next, it is assumed that generation device 100 generates an advertisement content B prior to the expiration date of advertisement content A (for example, on August 4). On this occasion, since the expiration date of catalog data A has already been expired but the expiration date of catalog data B is not expired yet, catalog data B is also stored in catalog data storage unit 131 as catalog data which can be published in an advertisement content. In addition, it is assumed that catalog data C and catalog data D are also stored in catalog data storage unit 131.

On this occasion, CPU 10 of generation device 100 determines that, of these three catalog data, catalog data C and catalog data D except for catalog data B, which has already been published in advertisement content A, are catalog data to be published in advertisement content B, as shown in FIG. 13B.

Prior to the expiration date of advertisement content A, both advertisement content A and advertisement content B thus generated are unexpired, and thus catalogs included in both advertisement contents are displayed. Accordingly, if the same catalog data A were published in both advertisement contents, display based on catalog data A would be provided redundantly in both advertisement contents. Thus, catalog redundancy can be avoided by determining catalog data to be published using the distribution registration history as described above.

After CPU 10 registers the generated advertisement content with content storage unit 132 in step S115, CPU 10 determines whether or not the distribution timing included in the determined distribution conditions have been reached. When the distribution timing have been reached (YES in step S117), CPU 10 distributes the advertisement content to terminal devices 300 in step S119.

### Effect of First Embodiment

As a result of the operation of generating and distributing the advertisement content described as the first embodiment performed in generation device 100, the number of catalogs to be published can be ensured while suppressing the file size of the advertisement content itself to be distributed to a predefined upper limit size, that is, suppressing cost for distribution.

On that occasion, catalogs having close expiration dates defined for the respective catalogs are published in the same advertisement content, and the expiration date of the advertisement content itself is determined in accordance with these expiration dates, which can suppress the number of catalogs in the advertisement content whose expiration dates have been expired and which become undisplayed when the advertisement content is distributed and displayed in the terminal devices. Therefore, a viewer can efficiently view unexpired catalogs with less number of views.

### Second Embodiment

Next, an operation of displaying an advertisement content in terminal devices 300 described in #4 of FIG. 4 will be described.

<Overview of Displaying Operation>

Each terminal device 300 stores an advertisement content distributed from generation device 100, and displays the advertisement content in accordance with a display instruction.

Terminal device 300 determines a publication position and a publication size for each catalog data in accordance with the reproduction conditions included in the advertisement content, and generates a display screen.

As described above, a plurality of catalogs are published in the advertisement content. Thus, all of the catalogs arranged on the display screen may not be displayed in display unit 35 of terminal device 300. Hence, terminal device 300 changes arrangements of the catalogs on the display screen at predetermined timing.

As an example, when the catalogs are arranged in order in one direction of the display screen as shown in FIG. 5, so-called rotation display may be performed, in which the arrangements of the catalogs are changed at predetermined timing, for example by shifting them one by one in order, arranging them randomly, or arranging them in a predetermined order. The predetermined timing may be timing to start display of the advertisement content, or regular time intervals from the start of display.

<Functional Configuration>

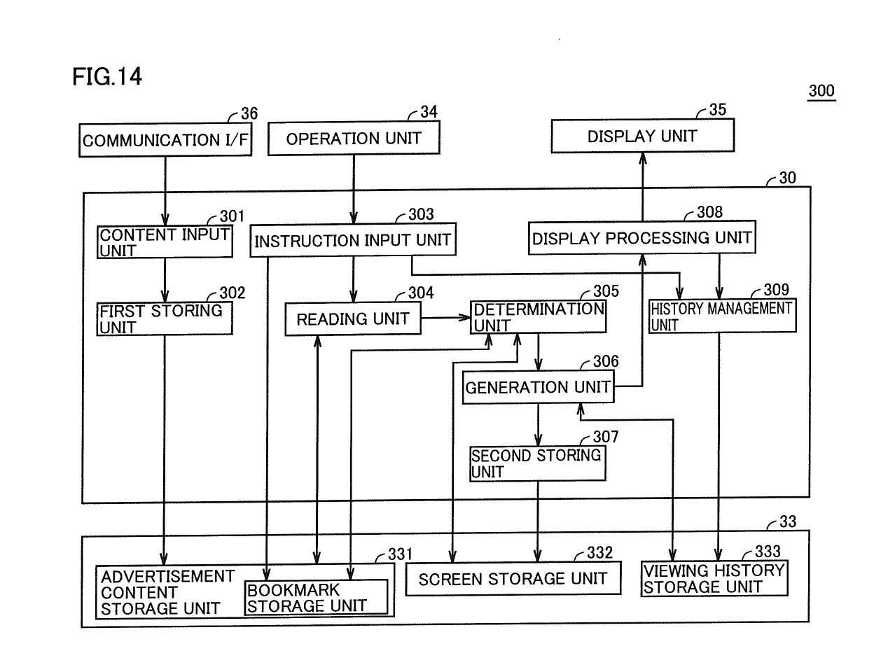

FIG. 14 is a block diagram showing a specific example of a functional configuration for performing the above operation in terminal device 300.

Each function shown in FIG. 14 is mainly configured on CPU 30 of terminal device 300 by CPU 30 reading a program stored in ROM 31, loading the program into RAM 32, and executing the program. However, at least a portion thereof may be implemented by the hardware configuration shown in FIG. 2.

Referring to FIG. 14, terminal device 300 includes, in memory 33, an advertisement content storage unit 331 as a storage area for storing downloaded advertisement contents, a screen storage unit 332 as a storage area for storing information indicating an arrangement of each catalog of an advertisement content in the display screen, and a viewing history storage unit 333 as a storage area for storing a viewing history indicating, for each catalog data included in the advertisement content, whether or not an instruction input for the corresponding catalog has been made in the display screen based on the advertisement content.

Advertisement content storage unit 331 further includes a bookmark storage unit as an area for storing a “bookmark”, which is information defining, for each catalog data, whether or not to set an arrangement in the display screen based on the advertisement content at a predefined position. The “bookmark” may be a flag indicating, for each catalog data, whether or not to set the arrangement at a defined position.

Further, as functions for displaying an advertisement content, terminal device 300 includes a content input unit 301 for receiving an advertisement content distributed from generation device 100 via communication I/F 36, a first storing unit 302 for storing the received advertisement content in advertisement content storage unit 331, an instruction input unit 303 for receiving an input of an operation signal in accordance with an instruction operation in operation unit 34, a reading unit 304 for reading a corresponding advertisement content from advertisement content storage unit 331 in accordance with a display instruction for an advertisement content, a determination unit 305 for determining an arrangement of each catalog in the display screen based on the advertisement content, a generation unit 306 for generating the display screen based on the advertisement content by arranging the catalogs, a second storing unit 307 for storing information indicating the arrangements of the catalogs in the generated display screen in screen storage unit 332, a display processing unit 308 for performing processing of displaying a predetermined area of the generated display screen in display unit 35, and a history management unit 309 for storing a viewing history for catalog data in viewing history storage unit 333 in accordance with an instruction input for a catalog made in the display screen based on the advertisement content.

Determination unit 305 stores beforehand a rule for changing the arrangements of the catalogs. Determination unit 305 reads previous arrangements of the catalogs from screen storage unit 332 and changes the arrangements in accordance with the above rule, and thereby determines arrangements of the catalogs in current display of the advertisement content.

If the publication position (arrangement) and the publication size of each catalog and the like are defined in the advertisement content as reproduction conditions on this occasion, determination unit 305 specifies the arrangement and size of a designated catalog in accordance with the reproduction conditions thereof.

Further, if a “bookmark” is added to catalog data included in the advertisement content on this occasion, the corresponding catalog is arranged at a predefined position.

Second storing unit 307 may store, in screen storage unit 332, information specifying the arrangement of each catalog determined by determination unit 305, or the display screen itself generated by arranging the catalogs.

For example, in the example of display in FIG. 5, when the “Browse” button or the “Download” button is pressed, history management unit 309 determines that the corresponding catalog has been viewed, and stores a viewing history for the corresponding catalog data in viewing history storage unit 333.

<Flow of Operation>

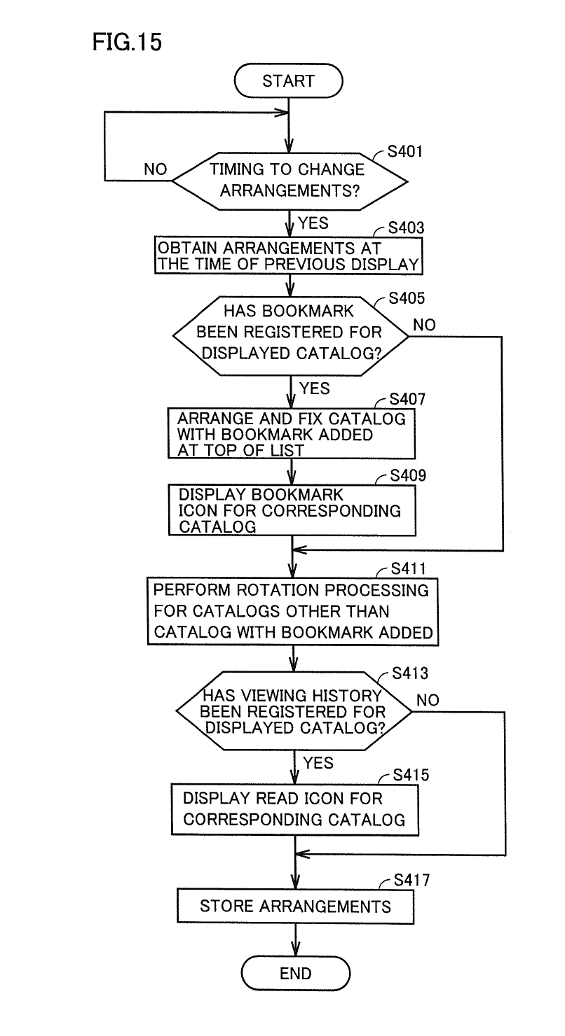

FIG. 15 is a flowchart showing a specific flow of the operation of displaying an advertisement content in terminal device 300. The operation shown in the flowchart of FIG. 15 is implemented by CPU 30 of terminal device 300 reading a program stored in ROM 31, loading the program into RAM 32 and executing the program, and causing each function in FIG. 14 to be exhibited.

Referring to FIG. 15, when CPU 30 detects timing to change arrangements of catalogs included in the advertisement content (YES in step S401), in step S403, CPU 30 reads arrangements of the catalogs when the advertisement content was previously displayed, from screen storage unit 332, and thereby obtains arrangements at the time of previous display.

Here, the timing to change the arrangements of the catalogs may be, for example, timing to start display of the advertisement content, or regular time lapses from the start of display.

CPU 30 reads an advertisement content to be displayed, and confirms whether or not catalog data included therein include catalog data with a “bookmark” added. As a result, when catalog data with a “bookmark” added is included (YES in step S405), in step S407, CPU 30 arranges the corresponding catalog at a predefined position in the display screen based on the advertisement content. Here, as an example, it is assumed that the catalogs are displayed in a list to be arranged from top to bottom, and a catalog with a “bookmark” added is defined to be arranged at the top of the list. In this case, in step S407, the catalog determined to have a “bookmark” added thereto is arranged at the top of the list, and the arrangement of the corresponding catalog is fixed.

Further, in step S409, CPU 30 performs processing for causing information which indicates that the corresponding catalog has a “bookmark” added thereto, to be also displayed. Here, as an example, an icon may be caused to be displayed.

Thereafter, in step S411, CPU 30 performs rotation processing for catalogs having no “bookmark” added thereto. It is noted that, when no “bookmark” is added to any of the catalog data (NO in step S405), CPU 30 skips the operations in steps S407, S409 and proceeds to step S411.

When the advertisement content is displayed, for example, with the catalogs being arranged in a list from top to bottom as described above, following three methods can be adopted as a method for rotation in step S411. Specifically, as a first method, positions of the catalogs are shifted one by one in order; as a second method, the positions thereof are determined randomly; and as a third method, the arrangements thereof are changed in accordance with the reproduction conditions included in the advertisement content.

FIG. 16 is a view for illustrating a specific example of the arrangements of the catalogs in the display screen.

Referring to FIG. 16, as an example, it is assumed that an advertisement content includes seven catalog data, and display frames 1 to 7, which are display areas for the catalogs, are provided from top to bottom in this order in the display screen. Of these, an area corresponding to display frames 1 to 5 serves as a display area in display unit 15. That is, the catalogs arranged in display frames 6, 7 are not displayed in display unit 15. In accordance with a scrolling operation in operation unit 34, the catalogs arranged in display frames 1 to 7 are changed to be displayed in different display frames.

FIGS. 17 to 19 are views for illustrating the first method to the third method, respectively, as the method for rotation described above. These drawings show a change in the arrangement of each catalog before and after the rotation.

Referring to FIG. 17, when rotation is performed by the first method, a catalog 1 arranged in display frame 1 before the rotation is moved to display frame 2 by rotation processing. Similarly, a catalog 2 arranged in display frame 2 is moved to display frame 3, and display positions are shifted in order.

Specifically, in the case of the first method, for each catalog, an index of a display frame in which the catalog is arranged before the rotation is incremented by 1. When the index reaches the number of catalog data +1 (in this example, 8), 1 is assigned as an index.

Thereby, in the case of the first method, the arrangements of the catalogs are changed such that the catalogs are moved downward in order, and the catalogs are equally displayed in display unit 35.

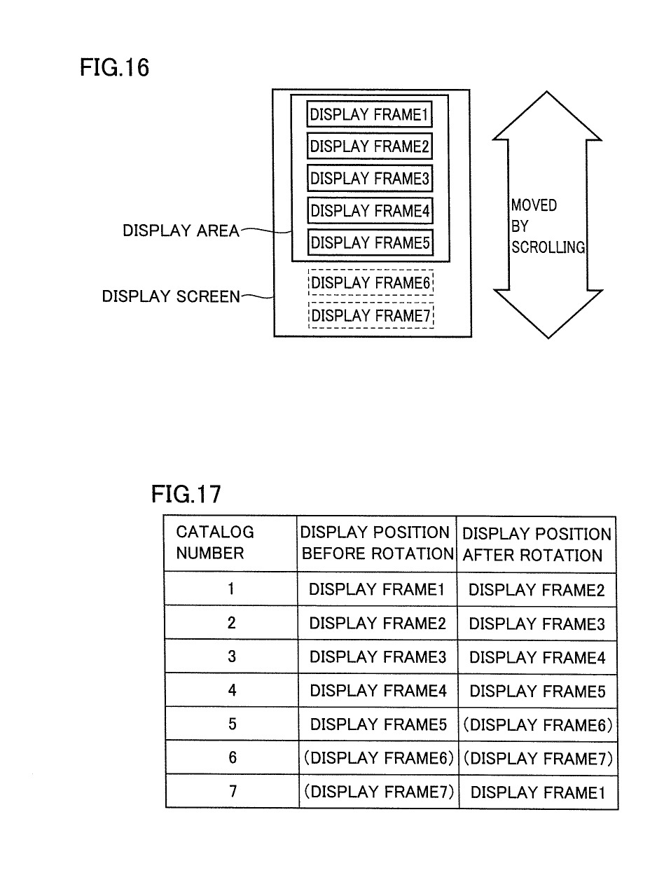

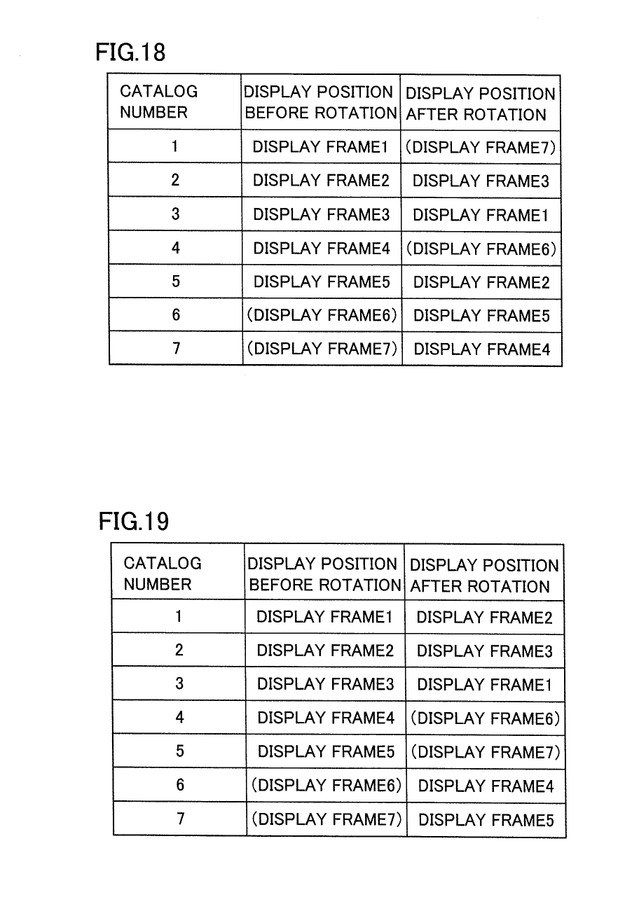

Referring to FIG. 18, as an example in which rotation is performed by the second method, for example, catalog 1 arranged in display frame 1 before the rotation is moved to display frame 7 by rotation processing. Catalog 2 arranged in display frame 2 is moved to display frame 3, and the catalogs are moved respectively.

As an example of the second method, the arrangement can be determined by using a value obtained by substituting a random number into a predefined equation, as an index of a display frame. An exemplary method includes assigning a catalog having a catalog number identical to the number obtained by adding 1 to the remainder of a division dividing a generated random number by the number of catalog data, as an example of a specific equation, to a display frame in order from display frame 1, until a display frame upper limit is reached.

Thereby, in the case of the second method, display positions of the catalogs are randomly changed, and the catalogs are substantially equally displayed in display unit 35.

Referring to FIG. 19, as an example in which rotation is performed by the third method, catalog 1 arranged in display frame 1 before the rotation is moved to display frame 2 by rotation processing. Catalog 2 arranged in display frame 2 is moved to display frame 3, and a catalog 3 arranged in display frame 3 is moved to display frame 1. Catalogs 4, 5 arranged in display frames 4, 5 are moved to display frames 6, 7, respectively, and catalogs 6, 7 arranged in display frames 6, 7 are moved to display frames 4, 5, respectively.

As an example of the third method, a reproduction condition defining a display pattern (scenario) of rotation is incorporated into the advertisement content beforehand as a distribution condition, and the arrangements can be determined in accordance with the reproduction condition. A specific example of a method for incorporating the reproduction condition as a distribution condition into the advertisement content includes a method for selecting a display pattern indicating how to perform rotation in accordance with a combination of priorities set for the respective catalogs, and describing the display pattern in the advertisement content using the JavaScript (registered trademark) language or the like. In this case, the display pattern as a reproduction conditions is defined beforehand to correspond to the combination of priorities set for the respective catalogs.

The reproduction condition included in the advertisement content used in the case of the third method shown in FIG. 19 is to rotate catalog data having priorities of display which are set higher in accordance with a publication price and the like, to be moved among display frame 1 to display frame 3 which are more frequently displayed (in this example, always displayed) in display unit 35 in order, and to display catalog data having priorities of display which are set lower, alternately in display frames 4, 5 and display frames 6, 7 which are less frequently displayed in display unit 35.

Thereby, in the case of the third method, the catalogs are displayed in display unit 35 in accordance with the reproduction condition such that the catalogs having priorities of display which are set higher in accordance with the attribute of the catalog data, for example a rank of the publication price and the like, to be displayed more frequently in display unit 35, and the catalogs having priorities of display which are set lower, to be displayed less frequently in display unit 35.

It is noted that an arrangement of a catalog having a priority of display which is set higher in the reproduction condition may be fixed to a predefined position which is displayed more frequently in display unit 35, and the catalogs having priorities of display which are not set higher may be moved among other positions, as in the following example of rotation processing in a case where catalog data with a “bookmark” added is included.

On the other hand, when the advertisement content includes catalog data with a “bookmark” added, in step S407, the arrangement of the catalog with the “bookmark” added is fixed, and the arrangements of other catalogs are determined by a method such as the first method to the third method.

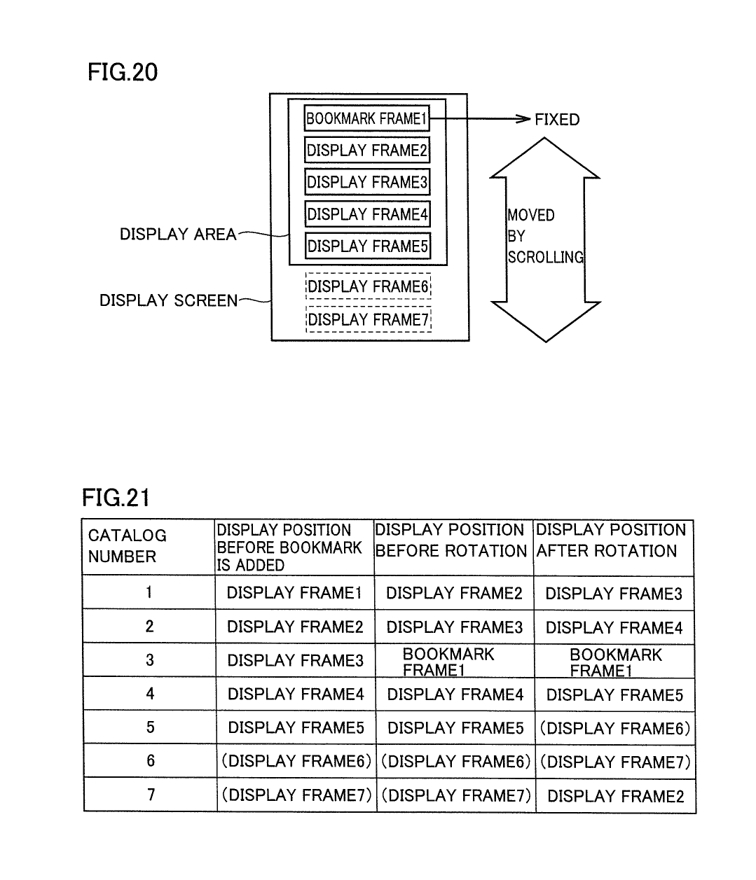

FIG. 20 is a view for illustrating a specific example of arrangements of catalogs in a display screen in a case where there is a catalog with a “bookmark” added.

Referring to FIG. 20, as an example, it is assumed that an advertisement content includes seven catalog data, and display frames 1 to 7, which are display areas for the catalogs, are provided from top to bottom in this order in the display screen, as in FIG. 16. When there is a catalog with a “bookmark” added, for example, display frame 1 at the top is set as a “bookmark frame 1”. In this case, the catalogs arranged in display frames 2 to 7 are changed to be displayed in different display frames in accordance with a scrolling operation in operation unit 34, and the catalog arranged in bookmark frame 1 is always arranged in the position of bookmark frame 1 irrespective of the scrolling operation.

The “bookmark frame” is not limited to be located at the position of display frame 1, and may be located at another position, for example the upper left corner or the like, as long as it is located in a display area always displayed in display unit 35 and at an eye-catching position in the display in display unit 35.

Since the catalog with the “bookmark” added is always arranged in bookmark frame 1 irrespective of the scrolling operation, the catalog with the “bookmark” added is always displayed in display unit 35 while the advertisement content is displayed, irrespective of the scrolling operation.

FIGS. 21 to 23 are views for illustrating the first method to the third method, respectively, as the method for rotation described above, in the case where there is catalog data with a “bookmark” added. These drawings show changes in the arrangement of each catalog before and after the “bookmark” is added, and before and after the rotation.

Referring to FIG. 21, when catalogs 1 to 7 are arranged in display frames 1 to 7, respectively, before a “bookmark” is added, and then a “bookmark” is added to catalog 3 arranged in display frame 3, catalog 3 is moved from display frame 3 to bookmark frame 1 at the position of display frame 1, and catalogs 1, 2 arranged in display frames 1, 2 are moved to display frames 2, 3, respectively.

When rotation is performed by the first method after the “bookmark” is added, catalog 1 arranged in display frame 2 before the rotation is moved to display frame 3 by rotation processing. Similarly, catalog 2 arranged in display frame 3 is moved to display frame 4, and display positions of the catalogs other than catalog 3 arranged in bookmark frame 1 are shifted in order.

Thereby, in the case of the first method, the arrangements of the catalogs other than the catalog with the “bookmark” added are changed such that the catalogs are moved downward in order, and the catalogs other than the catalog with the “bookmark” added are equally displayed in display unit 35.

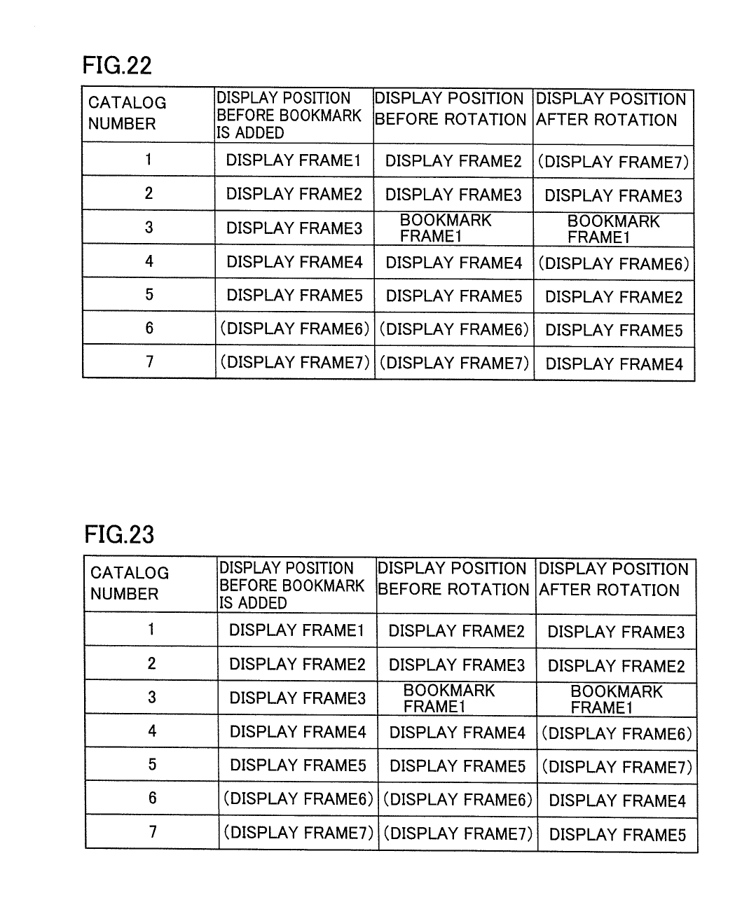

Referring to FIG. 22, when rotation is performed by the second method after the “bookmark” is added, for example, catalog 1 arranged in display frame 2 before the rotation is moved to display frame 7 by rotation processing. Catalog 2 arranged in display frame 3 is moved to display frame 3. Thus, the catalogs other than catalog 3 arranged in bookmark frame 1 are moved respectively.

Thereby, in the case of the second method, display positions of the catalogs other than the catalog with the “bookmark” added are randomly changed, and the catalogs other than the catalog with the “bookmark” added are substantially equally displayed in display unit 35.

Referring to FIG. 23, when rotation is performed by the third method after the “bookmark” is added, catalog 1 arranged in display frame 2 before the rotation is moved to display frame 3 by rotation processing. Catalog 2 arranged in display frame 3 is moved to display frame 2. Catalogs 4, 5 arranged in display frames 4, 5 are moved to display frames 6, 7, respectively, and catalogs 6, 7 arranged in display frames 6, 7 are moved to display frames 4, 5, respectively.

Thereby, in the case of the third method, display positions of the catalogs other than the catalog with the “bookmark” added are changed in accordance with the reproduction condition set in response to the attribute of the catalog data, for example, the rank of the publication price and the like, and the catalogs other than the catalog with the “bookmark” added are displayed in display unit 35 in accordance with the reproduction condition.

It is noted that, although the above example provides an example in which a “bookmark” is added to one of catalog data included in the advertisement content, “bookmarks” may be added to a plurality of catalog data. “Bookmarks” can be added to catalog data in a number up to the number of catalogs which can be displayed in display unit 35—1, that is, up to 6 catalog data in the above example.

Preferably, in step S409, as the information which indicates that the catalog has a “bookmark” added thereto, an icon is added to the catalog with the “bookmark” added, and displayed.

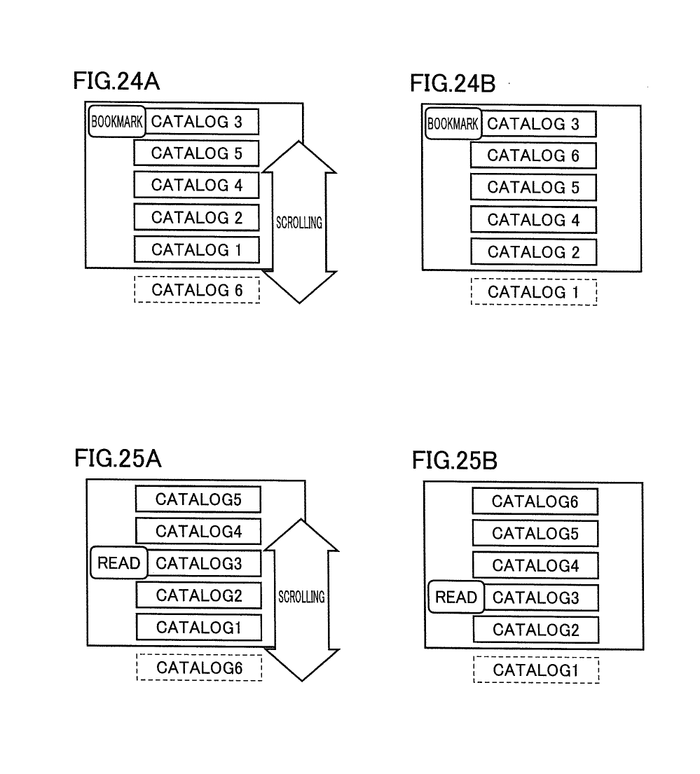

FIGS. 24A and 24B are views showing a display example in the case where there is a catalog with a “bookmark” added. In this example, a “bookmark” is added to catalog 3, and an icon indicating the “bookmark” is also displayed.

By using an icon or the like to indicate that a “bookmark” is added as described above, it is easily understood that catalog 3 with the “bookmark” added is not moved when scrolling is performed from the state shown in FIG. 24A to the state shown in FIG. 24B, and that the “bookmark” is added to catalog 3.

When the rotation processing in step S411 is completed and the arrangements of the catalogs are determined, CPU 30 confirms whether or not a viewing history has been registered for catalog data to be displayed. As a result, when there is catalog data for which a viewing history has been registered (YES in step S413), in step S415, CPU 30 performs processing for causing information which indicates that a viewing history has been registered for the corresponding catalog, to be also displayed. Here, as an example, an icon may be caused to be displayed.

FIGS. 25A and 25B are views showing a display example in a case where there is a catalog for which a viewing history has been registered. In this example, a viewing history has been registered for catalog 3, and an icon which indicates that the viewing history has been registered is also displayed.

By using an icon or the like to indicate that a viewing history has been registered, the icon is also displayed to be moved together with the catalog when scrolling is performed from the state shown in FIG. 25A to the state shown in FIG. 25B, and thus it is easily understood that catalog 3 is the catalog which has been viewed before.

When the arrangements of the catalogs included in the advertisement content are determined by the above processing, in step S417, CPU 30 stores information indicating the arrangements, and terminates a series of operations.

The arrangements stored herein is obtained in step S403 when the advertisement content is displayed next time, and by changing the arrangements, next arrangements are determined

### Effect of Second Embodiment

As a result of the operation of displaying the advertisement content described as the second embodiment performed in terminal device 300, every time when the advertisement content distributed from generation device 100 and once stored in terminal device 300 is displayed, the arrangements of the catalogs included in the advertisement content are changed. Thereby, even when terminal device 300 is a device having a display unit with a small area, for example a mobile phone or the like, and all the catalogs included in the advertisement content are not displayed at once, the catalogs are displayed in order.

On that occasion, the catalog designated using a “bookmark” or the like is always displayed, and other catalogs are substantially equally displayed. Further, the catalog with a “bookmark” added or the catalog having a viewing history which indicates, for example, that an instruction input has been made before in terminal device 300 is displayed together with an icon or the like indicating that matter, which makes a specific catalog distinguishable when a plurality of catalogs are displayed at once.

### Other Examples

Further, a program for causing generation device 100 to perform the operation of generating and distributing the advertisement content described above, and a program for causing terminal device 300 to perform the operation of displaying the advertisement content described above can also be provided. Such a program can be provided as a program product by being recorded in a computer readable recording medium such as a flexible disk, a CD-ROM (Compact Disk-Read Only Memory), a ROM, a RAM, and a memory card attached to a computer. Alternatively, a program can be provided by being recorded in a recording medium such as a hard disk built in a computer. Alternatively, a program can be provided by download through a network.

It is noted that the program in accordance with the present invention may be the one which invokes necessary modules of program modules provided as a portion of an operating system (OS) of a computer, in a predetermined sequence, at predetermined timing, to cause processing to be performed. In that case, the above modules are not included in the program itself, and processing is performed in cooperation with the OS. Such a program not including modules may also be included in the program in accordance with the present invention.

Further, the program in accordance with the present invention may be the one which is incorporated into a portion of another program and provided. Also in that case, modules included in the other program are not included in the program itself, and processing is performed in cooperation with the other program. Such a program incorporated into another program may also be included in the program in accordance with the present invention.

A provided program product is installed in a program storing unit such as a hard disk and executed. It is noted that a program product includes a program itself and a recording medium in which the program is recorded.

### REFERENCE SIGNS LIST

1: system; 10, 30: CPU; 11, 31: ROM; 12, 32: RAM; 13, 33: memory; 14, 34: operation unit; 15, 35: display unit; 51: advertisement determination unit; 52, 304: reading unit; 53: adjustment unit; 54: condition determination unit; 100: generation device; 101: data input unit; 102: list input unit; 103: request input unit; 104: storing unit; 105: advertisement content generation unit; 106: registration unit; 107: download executing unit; 108: distribution executing unit; 109, 309: history management unit; 131: catalog data storage unit; 132: content storage unit; 133: schedule storage unit; 200, 200A, 200B, 200C: provision device; 300, 300A, 300B, 300C: terminal device; 301: content input unit; 302: first storing unit; 303: instruction input unit; 305: determination unit; 306: generation unit; 307: second storing unit; 308: display processing unit; 331: advertisement content storage unit; 332: screen storage unit; 333: viewing history storage unit.

1. A display device, comprising:
a storage unit for storing display data generated from a plurality of respective content data;
a display unit; and
a processing unit for generating a display screen based on said display data and causing said display unit to display a predetermined area of said display screen,
wherein said processing unit performs:
processing of changing arrangements of said plurality of respective content data in said display screen at predetermined timing, in accordance with a preset rule; and
processing of storing the arrangements of said plurality of respective content data in said display screen when display based on said display data is terminated, and
said processing unit determines arrangements changed in accordance with said rule from arrangements of said plurality of respective content data in said display screen when previous display based on said display data is terminated, which have been stored by said processing of storing, as arrangements of said plurality of respective content data in said display screen when next display based on said display data is started.

2. The display device according to claim 1, further comprising a reception unit for receiving designation of specific content data of said plurality of content data included in said display data,
wherein said processing unit sets an arrangement of said designated content data in said display screen at a predefined position, and, in said processing of changing the arrangements, changes arrangements of content data other than said designated content data of said plurality of content data, at positions other than said predefined position in said display screen, at said predetermined timing.

3. The display device according to claim 1, wherein, in said processing of changing the arrangements, said processing unit changes the arrangements in accordance with priorities of display defined for said plurality of respective content data, at positions predefined in response to the priorities on said display screen.

4. The display device according to claim 3, wherein, in said processing of changing the arrangements, said processing unit arranges content data with a higher priority of display of said plurality of content data, within a range of said display screen which is more frequently displayed in said display unit.

5. The display device according to claim 3, wherein, in said processing of changing the arrangements, said processing unit fixes content data with a higher priority of display of said plurality of content data, at a predefined position in said display screen, and changes arrangements of content data other than said content data with the higher priority of said plurality of content data, at positions other than said predefined position in said display screen, at said predetermined timing.

6. A display method for generating a display screen based on display data generated from a plurality of respective content data and displaying a predetermined area of said display screen in a display device, comprising the steps of:
determining arrangements of said plurality of respective content data in said display screen;
changing the arrangements of said plurality of respective content data in said display screen at predetermined timing, in accordance with a preset rule; and
storing the arrangements of said plurality of respective content data in said display screen when display based on said display data is terminated,
wherein, when next display based on said display data is started, said step of determining the arrangements determines arrangements changed in accordance with said rule from arrangements of said plurality of respective content data in said display screen when previous display based on said display data is terminated, which have been stored by said step of storing, as arrangements of said plurality of respective content data in said display screen when said next display based on said display data is started.

7. A non-transitory computer readable recording medium storing a display program for causing a display device to perform processing of generating a display screen based on display data generated from a plurality of respective content data and displaying a predetermined area of said display screen, said program allowing said display device to perform the steps of:
determining arrangements of said plurality of respective content data in said display screen;
changing the arrangements of said plurality of respective content data in said display screen at predetermined timing, in accordance with a preset rule; and
storing the arrangements of said plurality of respective content data in said display screen when display based on said display data is terminated,
wherein, when next display based on said display data is started, said step of determining the arrangements determines arrangements changed in accordance with said rule from arrangements of said plurality of respective content data in said display screen when previous display based on said display data is terminated, which have been stored by said step of storing, as arrangements of said plurality of respective content data in said display screen when said next display based on said display data is started.
